(19) United States
(12) Patent Application Publication
(10) Pub. No.: US 2010/0200148 A1
(43) Pub. Date: Aug. 12, 2010

(54) MEMBRANE HAVING A CURED COATING LAYER

(76) Inventor: Bruce F. DOUGLAS, Zionsville, IN (US)

Correspondence Address: BRIDGESTONE AMERICAS, INC., 1200 FIRESTONE PARKWAY, AKRON, OH, 44317, US

(21) Appl. No.: 12/703,321

(22) Filed: Feb. 10, 2010

Related U.S. Application Data
(60) Provisional application No. 61/151,991, filed on Feb. 12, 2009.

(51) Int. Cl. E04D 5/00; B32B 3/00; B05D 3/02; B05D 3/10; B05D 3/12; B05D 3/06

(52) U.S. Cl. 156/71; 428/189; 427/385.5; 427/340; 427/177; 427/508

(57) ABSTRACT

A chemically coated roofing membrane assembly includes a membrane and a chemical coating on at least a portion of one surface of the membrane. In one or more embodiments, the chemical coating may be provided along the top surface of the membrane adjacent to a longitudinal edge of the membrane, and along the bottom surface of the membrane adjacent to a second longitudinal edge of the membrane. The chemical coating is cured, and may be formed from acrylic or urethane chemical compositions. The chemically coated roofing membrane eliminates the need for in-field priming of the membrane.

This application claims the benefit of U.S. Provisional Patent Application Ser. No. 61/151,991, filed on Feb. 12, 2009, which is incorporated herein by reference.

### FIELD OF THE INVENTION

One or more embodiments of the present invention relate to a roofing membrane having a cured coating layer over part or all of the membrane. The membrane may include a cured coating layer on one or more edges of the membrane.

### BACKGROUND OF THE INVENTION

The construction industry commonly uses single ply membranes to provide a waterproof barrier on flat or low-slope roofs. It is prohibitively expensive and difficult to produce and transport a single membrane that is sized to cover an entire roof surface, thus, a plurality of individual membranes are provided and oriented in an overlapping arrangement. The overlapping portions, or splices, of these individual membranes must be secured together to ensure that the plurality of membranes form a single waterproof surface.

One attachment approach is to secure the adjoining membranes together using an adhesive tape. These tapes are positioned between adjacent membrane surfaces and when the surfaces are brought together, the membranes are thereafter secured together. In order to ensure that these tapes effectively bond the adjoining membranes, the areas where tape application occurs are conventionally prepared using a primer. The primer application removes dirt and other debris that may inhibit bonding. Further, the primer leaves a tacky film upon which the adhesive tape is applied. This preparation process enhances the adhesion of the tape and consequently helps prevent leaking and/or separation in the splice area.

Priming is particularly important when adhering a thermoset membrane such as a membrane fabricated from EPDM rubber (ethylene-propylene-diene rubber). These membranes are typically cured while rolled on a mandrel. This, of course, is necessitated by the size of the membrane and limitations on the practical size of an oven in which the membrane is cured. In order to roll an uncured membrane onto itself and subsequently cure the rolled membrane without creating a solid, cured cylinder of rubber, the planar faces of the membrane are treated with talc or another dusting agent to prevent the planar faces of the membrane from curing to each other. This talc or dusting agent later presents problems when attempting to adhere membranes together to form a waterproof splice. The use of primers in conjunction with mechanical agitation through scrubbing dislodges and removes sufficient talc or other dusting agent to allow the adhesive to form a useful splice.

In most situations, primers are applied to the membranes while in the field just before the tape adhesive is applied to the membrane. The tape adhesive, which typically carries a release liner, is then applied. The release liner may be paper or plastic-based material possessing engineered release characteristics to prevent unwanted adhesion and allow proper unrolling and placement of tape on the primed membrane. After the tape is applied to the primed membrane, the release liner is removed to expose the top side of the tape adhesive. The overlapping primed portion of the adjoining membrane is then mated to the tape adhesive to affix the two membranes together and create a water tight barrier at the lap areas between adjacent membrane panels.

Field priming of the membrane panels is performed by roofing mechanics. Therefore, field priming of the membrane panels is subject to improper application. For example, roof mechanics may not apply enough primer or apply it unevenly. They may also apply the tape before the flash-off period is complete, which leads to degradation of the resulting tape adhesive bond. Or, the mechanic may apply the tape too long after primer application, which allows dirt and moisture to collect on the primed surfaces. In each of the above instances, the integrity of the field seams may be jeopardized.

Also, federal, state and local governments, as well as other agencies, continue to regulate and reduce the amount of volatile organic compounds that can be released into the environment. Solvent-based primers are a source of volatile organic compounds. While water based primers can eliminate the release of volatile organic compounds during priming, water-based primers have some disadvantages, including their service temperatures.

In addition to roofing membrane panels, roof flashing also conventionally requires application of an adhesive primer as discussed above. Roof flashing is commonly available to contractors in narrow rolls, which are typically used for repairs or for detail work on roofing systems. They are secured to the roofing membranes or to underlying substrates by use of adhesive tape similar to that used in conjunction with the roof membranes. Thus, the application of the adhesive-primer to flashing at the jobsite is subject to the same limitations and disadvantages as with the on-site application of membrane primers. Particularly, seams may have compromised integrity due to improper application of the primer by roofing mechanics.

An alternative method of priming roofing membranes has been contemplated and includes priming the membranes during the process of manufacturing the roofing membranes and prior to shipment, as disclosed in detail in co-pending PCT Patent Application WO2008/091661 filed on Jan. 24, 2008. While this method of pre-priming a roofing membrane is effective in addressing several of the problems discussed herein, it also presents several unique problems and inefficiencies. One problem is the necessity to protect the pre-primed area of the membrane during storage and shipment due to its tackiness. Release liners, similar to those used on adhesive tapes, are applied to the pre-primed edges prior to rolling of the membrane for storage and shipment. The introduction of the release liners adds to the time and cost necessary to manufacture the membranes. Furthermore, where solvent-based primers are used, volatile organic compounds must be managed and dealt with in the factory.

Thus, there exists a need in the art for means to provide factory-prepared areas of roofing membranes and roof flashing in a manner that reduces the risk of roofer misapplication and/or release of volatile organic compounds in the field.

### SUMMARY OF THE INVENTION

One or more embodiments of the present invention provide a roofing membrane assembly including a membrane having a top surface, a bottom surface, a first longitudinal edge, and a second longitudinal edge. The roofing membrane assembly also includes a cured-coating layer along one of the first longitudinal edge on the top surface and the second longitudinal edge on the bottom surface. The cured-coating layer of the roofing membrane assembly provides a bonding surface.

One or more embodiments of the present invention also provides a method of installing a membrane assembly on a roof surface including positioning a first membrane assembly on the roof surface, the membrane having a top surface, a first longitudinal edge, and a cured-coating layer along the first longitudinal edge of the top surface. The process then includes positioning a second membrane assembly on the roof surface, the membrane having a bottom surface, a second longitudinal edge, and a cured-coating layer along the second longitudinal edge of the bottom surface. The second membrane assembly overlaps the first membrane assembly when positioned on the roof surface. The method also includes applying an adhesive tape to the cured-coating layer of the first membrane assembly and pressing the cured-coating layer of the second membrane assembly against the adhesive tape to form a lap seam between the first membrane assembly and the second membrane assembly.

One or more embodiments of the present invention also provides a method of making a membrane having a cured-coating layer including extruding a membrane, applying a coating composition to at least part of the membrane to form a coating layer, and curing the membrane and the coating layer to form a cured-coating layer on the membrane.

### BRIEF DESCRIPTION OF THE DRAWINGS

FIG. 1 is a fragmentary perspective view of a membrane assembly made according to the methods of the present invention;

FIG. 2 is a fragmentary perspective view of another embodiment of the membrane assembly of the present invention;

FIG. 3 is a fragmentary perspective view showing edges of two roofing membrane assemblies to be secured together by adhesive tape;

FIG. 4 is a fragmentary perspective view showing the roofing membrane assemblies of FIG. 3 in an adhered state; and

FIG. 5 is a fragmentary perspective view of roofing flashing made according to the methods of the present invention.

### DETAILED DESCRIPTION OF THE ILLUSTRATIVE EMBODIMENTS

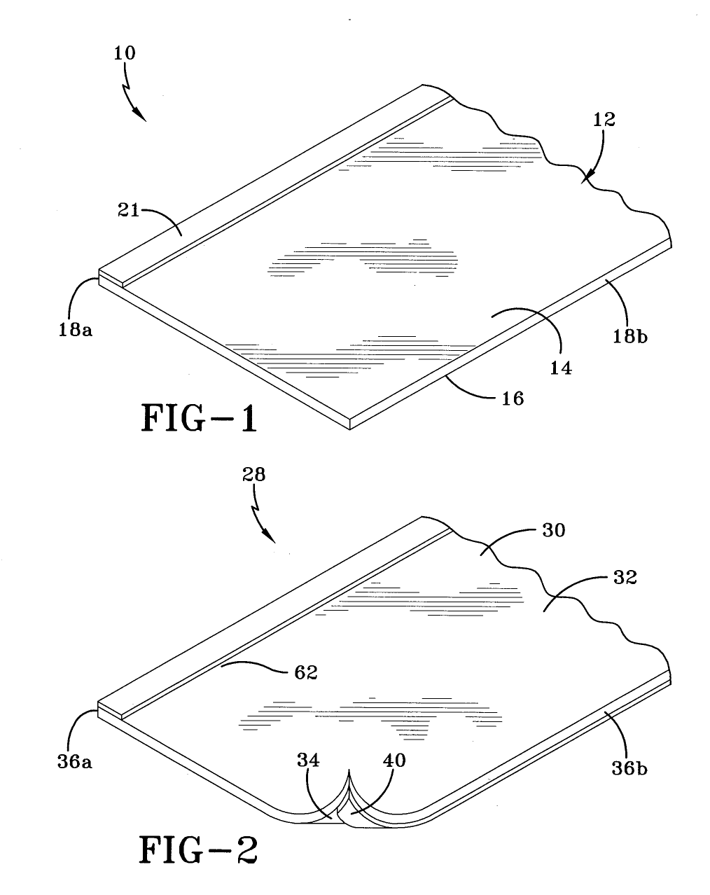

Referring to FIG. 1, a membrane assembly is shown, and is generally indicated by the numeral 10. Membrane assembly 10 includes a membrane 12 that is preferably waterproof and weather resistant. Practice of the present invention is not necessarily limited by the selection of a particular roofing membrane that is secured to a substrate on a roof surface. As is known in the art, numerous roofing membranes have been proposed in the art and several are used commercially including thermoset and thermoplastic roofing membranes. Commercially available thermoplastic roofing membranes may include polyvinyl chloride, or polyolefin copolymers. For example, thermoplastic olefin (TPO) membranes are available under the tradenames UltraPly™, and ReflexEON™ (Firestone Building Products). Commercially available thermoset roofing membranes may include elastomeric copolymers such as ethylene-propylene-diene copolymer (EPDM) rubber and functionalized olefins such as chlorosulfonated polyethylene (CSPE). For example, EPDM membranes are available under the tradename RubberGard™, RubberGard Platinum™, RubberGard EcoWhite™, and RubberGard MAX™ (Firestone Building Products).

In particular embodiments, EPDM membranes are employed. As is known in the art, EPDM membrane panels include vulcanized or cured rubber compositions. These compositions may include, in addition to the rubber that is ultimately vulcanized, fillers, processing oils, and other desired ingredients such as plasticizers, antidegredants, adhesive-enhancing promoters, etc., as well as vulcanizing agents such as sulfur or sulfur-donating compounds.

In one or more embodiments, the EPDM roofing panels have a thickness in accordance with ASTM D-4637-04. In one or more embodiments, the EPDM roofing panels have a thickness of at least 45 mil±10%, in other embodiments at least 60 mil±10%, and in other embodiments at least 90 mil±10%. In these or other embodiments, the EPDM roofing panels may have a thickness of less than 65 mil±10%, in other embodiments less than 80 mil±10%, and in other embodiments less than 110 mil±10%.

Membrane 12 includes a top planar surface 14 and a bottom planar surface 16. Membrane 12 may be in the form an elongated sheet and include a pair of spaced longitudinal edges 18a and 18b. In one or more embodiments, membrane 12 may be from about 25 to about 400 feet (8-122 m) in the longitudinal direction. Longitudinal, as used herein, refers to the direction and/or dimension generally parallel to longitudinal edges 18a and 18b. In these or other embodiments, membrane 12 may be from about 5 to about 50 feet (1.5-15 m) in the transverse direction. It will be understood by those skilled in the art that the transverse direction and/or dimension is generally orthogonal to longitudinal edges 18a and 18b.

In the present embodiment, a cured-coating layer 21 is provided on a portion of top surface 14 adjacent longitudinal edge 18a. Cured-coating layer 21 provides a bonding surface for adhesive tape used to bond two adjacent membranes together on a roof surface. In one or more embodiments, cured-coating layer 21 is disposed adjacent to substantially the entire longitudinal edge 18a. In these or other embodiments, cured-coating layer 21 may extend from longitudinal edge 18a along top surface 14 in a transverse direction for a distance of between approximately 1 and 12 inches (25-305 mm), in other embodiments a distance of between approximately 3 and 8 inches (76-203 mm), and in still other embodiments a distance of less than approximately 10 inches (254 mm).

With reference now to FIG. 2, an alternative embodiment of the membrane assembly is shown, which is indicated generally by the numeral 28. In this embodiment, a membrane 30, similar to membrane 12 discussed above, is provided, and includes a top planar surface 32 and a spaced bottom surface 34. Membrane 30 also includes spaced longitudinal edges 36a and 36b.

In the embodiment shown, a cured-coating layer may be provided over several different portions of membrane 30, and may be provided on opposing surfaces of membrane 30. In one or more embodiments, the cured-coating layer is provided on a portion of top surface 32 adjacent longitudinal edge 36a forming a top cured-coating layer 39 and on a portion of bottom surface 34 adjacent longitudinal edge 36b forming a bottom cured-coating layer 40. Top cured-coating layer 39 and bottom cured-coating layer 40 each provide a bonding surface for adhesive tape used to bond two adjacent membranes together when installed on a roof surface, as will be discussed in detail below.

In one or more embodiments, cured-coating layers 39 and 40 are disposed adjacent to substantially the entire longitudinal edges 36a and 36b of membrane 30, respectively. In these or other embodiments, top cured-coating layer 39 and bottom cured-coating layer 40 may each extend from a longitudinal edge 36a or 36b in a transverse direction for a distance of between approximately 1 and 12 inches (25-305 mm), in other embodiments a distance of between approximately 3 and 8 inches (76-203 mm), and in still other embodiments a distance of less than approximately 10 inches (254 mm).

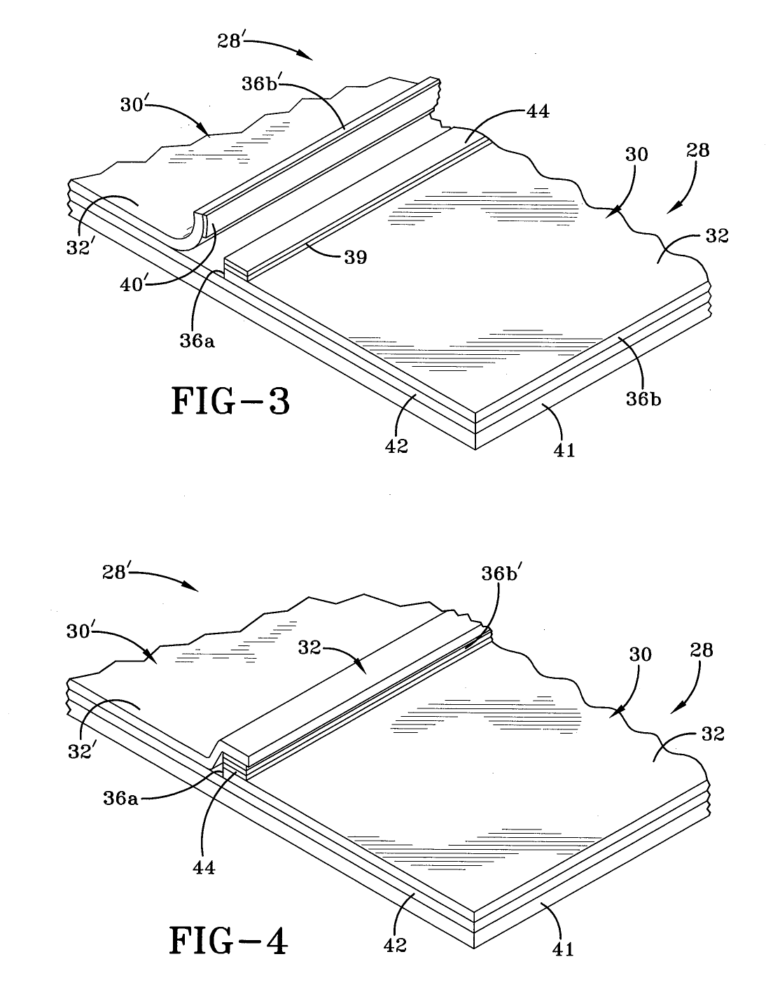

A method of installing membrane assembly 28 will now be described with reference to FIGS. 3 and 4. In a first step, a first membrane assembly 28, as described with respect to FIG. 2, is positioned on a roof surface. In one or more embodiments, the roof surface may include a roof deck 41 that supports the various roof components. In the same or other embodiments, an insulation layer 42 may be provided on top of roof deck 41 that helps prevent thermal gain during warm periods and thermal loss during cold periods.

In a second step, a second membrane assembly 28′ is positioned next to first membrane assembly 28. Second membrane assembly 28′ is positioned so that bottom cured-coating layer 40′ along longitudinal edge 36b′ of the second membrane 28′ is positioned adjacent to and parallel with the top cured-coating layer 39 along longitudinal edge 36a of the first membrane assembly 28. First membrane assembly 28 and second membrane assembly 28′ are positioned so that longitudinal edge 36b′ of the second membrane assembly 28′ and longitudinal edge 36a of the first membrane assembly 28 overlap each other. The overlapping portion of the membranes allows for a lap seam to be created between top cured-coating layer 39 and bottom cured-coating layer 40′.

In a third step, an adhesive tape 44 is applied to top cured-coating layer 39 of the first membrane assembly along substantially the entire longitudinal edge 36a, as shown in FIG. 3. The adhesive tape 44 of the present invention may be a solid adhesive, which may also be referred to as a solid adhesive strip, and may include those that are conventional in the art. In one or more embodiments, adhesive tape 44 may include EPDM and/or butyl rubber. In one or more embodiments, the adhesive tape 44 includes at least 85% solids. In other embodiments, the adhesive tape 44 includes at least 90% solids. In still other embodiments, the adhesive tape 44 includes at least 95% solids. In yet other embodiments, the adhesive tape 44 includes at least 99% solids. In one or more embodiments, the adhesive tape includes a thickness of greater than 0.007 inches (0.178 mm). In other embodiments, the tape includes a thickness greater than 0.01 inches (0.25 mm). In still other embodiments, the adhesive tape includes a thickness greater than 0.1 inches (2.54 mm).

Useful adhesive tapes are disclosed in U.S. Pat. Nos. 6,120,869, 5,888,602, 5,859,114, 5,733,621, 5,612,141, 5,563,217, 5545685, 5,504,136, 5,242,727, 4,932,171, 4,849,268, 4,657,958, 4,855,172, 4,588,637, 4,539,344, and 4,426,468, which are incorporated herein by reference. Useful tapes are commercially available including those available under the trade names QuickSeam™ (Firestone), PLIOSEAL™ (Ashland), 510™ (ADCO), 505™ (ADCO).

In a fourth step, shown in FIG. 4, the bottom cured-coating layer 40′ of bottom surface 34′ of second membrane 30′ is pressed into contact with adhesive tape 44. In this manner, a water-resistant lap seam 46 is formed between first membrane assembly 28 and second membrane assembly 28′. As is evident, a time savings is achieved by factory applying the cured-coating layers 39 and 40 prior to roof installation, as no in-field priming is required. Likewise, release of volatile organic compounds from the primer is reduced.

It should be appreciated that the above referenced method may be varied without departing from the teachings of the present invention. For example, the membrane assembly 10 shown in FIG. 1 may be installed in the same manner, but will require priming along an edge of a second membrane on its bottom surface prior to pressing it into contact with the adhesive tape 44. Further, tape 44 may be applied first to the second membrane assembly 28′ and then pressed into contact with the first membrane assembly 28. Other variations of the method described herein will be apparent to those skilled in the art.

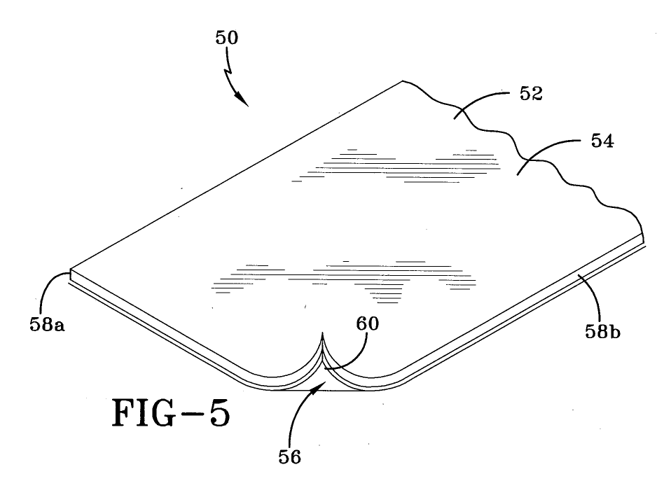

Referring now to FIG. 5, a third alternative embodiment of the invention is shown. In this embodiment, a flashing assembly is provided and is generally indicated by the numeral 50. Flashing assembly 50 includes a flashing membrane 52 having a top surface 54 and a spaced bottom surface 56. Flashing membrane 52 may be made of the same materials as used to make the membranes described hereinabove, such as EPDM, and may be used in a variety of ways. For example, flashing membrane 52 may be used to repair existing membrane assemblies, in the installation of detail work on a roof assembly, as a batten cover, as a gravel stop flashing and as perimeter flashing. Flashing membrane 52 may also be made of other materials, such as Neoprenem (Dupont) and polybutadiene rubber.

Flashing membrane 52 may be in the form of an elongated and narrow sheet and may include a pair of spaced longitudinal edges 58a and 58b. In one or more embodiments, flashing membrane 52 may have a longitudinal length of between approximately 50-100 feet (15-30 m). In these or other embodiments flashing membrane 52 may have a width in the transverse direction of between approximately 3-50 inches (76-1270 mm). In these or other embodiments, flashing membrane 52 may have a thickness of between approximately 0.030 to 0.075 inches (0.76-1.9 mm). As used herein, thickness refers to the distance between top surface 54 and bottom surface 56 of membrane 52.

A cured coating is disposed on at least a portion of bottom surface 56 of flashing membrane 52, creating a cured-coating layer 60. Cured-coating layer 60 provides an adhesive bonding surface for flashing membrane 52, and is substantially non-tacky. In a preferred embodiment, as shown in FIG. 5, cured-coating layer 60 is disposed on substantially all of bottom surface 56. In one or more embodiments, an adhesive may be applied to cured-coating layer 60 or to an existing surface, such as an existing roofing membrane assembly, and flashing membrane 52 may then be pressed against the surface to be secured thereon. The inclusion of cured-coating layer 60 alleviates the need for any in-field priming by technicians during the installation of flashing membrane 52.

In one or more embodiments, the cured-coating layers described above (e.g. cured coating layers 21, 39, 40 and 60) may include any cured or crosslinked polymer that can adhere to the substrate (e.g. the membrane). In one or more embodiments, the cured coating is cured or cross-linked to an extent that the cured or crosslinked polymer is not soluble to any significant degree in conventional organic solvents such as cyclohexone or xylene. In particular embodiments, less than 25 wt %, in other embodiments less than 15 wt %, and in other embodiments less than 5 wt % of the cured or crosslinked polymer is soluble in cyclohexone at around the boiling point of cyclohexone at standard pressure.

In one or more embodiments, the cured-coating layer (e.g. 21, 39, 40 and 60) is generally non-tacky, and therefore does not require a release liner for storage or shipment of the membrane or flashing (12, 30 and 52). The term non-tacky, as used herein, refers to the adhesive properties of the cured-coating, and should be interpreted as meaning a lack of any significant adhesive characteristics.

In one or more embodiments, the cured coating derives from a coating composition that may be cured. Cured, as used herein, refers to the application of an energy source to create a crosslinked coating, or gel. Depending on the chemical constituents of the coating composition, the coating may be cured via solvent evaporation and/or via a source of energy such as heat or UV radiation. In particular embodiments, the coating composition is an acrylic casting composition that is UV-curable. In other embodiments, the coating composition is a one-part urethane composition that may be moisture curable. In certain embodiments, the coating composition may be fast curing.

In one or more embodiments, the coating composition may have a set-up time (drying time) of less than about sixty seconds, in other embodiments less than about 45 seconds, and in other embodiments less than about 30 seconds. The set-up time, as used herein, refers to the amount of time required for the coating composition to no longer have any tack, allowing the membrane to which it is applied to be rolled on itself. It is also contemplated that, in lieu of a coating composition, a thin film may be applied to the membrane to create a cured-coating layer.

A method of manufacturing a membrane assembly or flashing membrane assembly according to the present invention will now be discussed. For purposes of the discussion of the manufacturing process, the term membrane may be used to refer to either a roofing membrane or a flashing membrane as discussed above. In one or more embodiments, the membrane is first formed through an extrusion die, as is known to persons skilled in the art. After extrusion, in the case of an EPDM membrane, the membrane is in an uncured state, and is often referred to in this state as a “green” membrane.

In one or more embodiments, the green membrane is then coated with a coating composition to create one or more coating layers on the surface of the membrane, or on a portion thereof. The coating composition may be applied by any method known to those skilled in the art, including, for example, using a metering rod, a spray applicator, a roller, brushes, or a dipping mechanism. The coating composition may be applied to several areas of the membrane simultaneously, or may be applied to one or more areas of the membrane in succession. In one or more embodiments, the coating composition may have a thickness of less than approximately 20 mils at the conclusion of the set-up time, in other embodiments less than approximately 15 mils at the conclusion of the set-up time, and in still other embodiments less than approximately m mils at the conclusion of the set-up time.

In one or more embodiments, after being coated with the coating composition, the coating is allowed to dry until it is substantially non-tacky. Or, in other words, the solvent portion of the coating is allowed to evaporate. When the coating composition has dried, the membrane then proceeds to a dusting station where it is dusted to prevent it from sticking to itself, as is well known in the art. Dusting agents may include any known dusting agents. In one or more embodiments, talc or mica may be used as a dusting agent. The dusting agent will not adhere to the dried coating composition due to the lack of significant tack of the composition. In one or more embodiments, the membrane is then rolled and transported to an autoclave, where it is cured using known procedures. In one or more embodiments, the membrane may be UV cured. The curing of the membrane also acts to cure the cured-coating layer provided on the membrane.

Various modifications and alterations that do not depart from the scope and spirit of this invention will become apparent to those skilled in the art. This invention is not to be unduly limited to the illustrative embodiments set forth herein.

1. A roofing membrane assembly comprising:
a membrane having a top surface, a bottom surface, a first longitudinal edge, and a second longitudinal edge; and
a cured-coating layer along one of said first longitudinal edge on said top surface and said second longitudinal edge on said bottom surface, where said cured-coating layer provides a bonding surface.

2. A roofing membrane assembly according to claim 1, wherein said membrane is between approximately 25 ft to 400 ft long in the longitudinal direction.

3. A roofing membrane assembly according to claim 1, wherein said membrane is between approximately 3 ft to 50 ft wide in the transverse direction.

4. A roofing membrane assembly according to claim 1, wherein said membrane is made of EPDM.

5. A roofing membrane assembly according to claim 1, wherein said cured-coating layer is made of an acrylic composition.

6. A roofing membrane assembly according to claim 1, wherein said cured-coating layer is made of a urethane composition.

7. A roofing membrane assembly according to claim 1, wherein said cured-coating layer is substantially non-tacky.

8. A roofing membrane assembly according to claim 1, further comprising a second cured-coating layer along the other of said first longitudinal edge on said top surface and said second longitudinal edge on said bottom surface.

9. A roofing membrane assembly according to claim 1, wherein said cured-coating layer extends a distance of between approximately 3 to 12 inches in the transverse direction.

10. A roofing membrane assembly according to claim 8, wherein said cured-coating layer extends a distance of between approximately 3 to 12 inches in the transverse direction on said top surface of said membrane, and said second cured-coating layer extends a distance of between approximately 3 to 12 inches in the transverse direction on said bottom surface of said membrane.

11. A method of installing a membrane assembly on a roof surface comprising:
positioning a first membrane assembly on the roof surface, the membrane having a top surface, a first longitudinal edge, and a cured-coating layer along the first longitudinal edge of the top surface;
positioning a second membrane assembly on the roof surface, the membrane having a bottom surface, a second longitudinal edge, and a cured-coating layer along the second longitudinal edge of the bottom surface, wherein the second membrane assembly overlaps the first membrane assembly;
applying an adhesive tape to the cured-coating layer of one of the first membrane assembly and the second membrane assembly; and
pressing the cured-coating layer of the other of the first membrane assembly and the second membrane assembly against the adhesive tape to form a lap seam between said first membrane assembly and said second membrane assembly.

12. A method of installing a membrane assembly on a roof surface according to claim 11, wherein the removal of a release liner from a membrane is not required.

13. A method of installing a membrane assembly on a roof surface according to claim 12, wherein applying a primer to the membrane is not required.

14. A method of making a membrane having a cured-coating layer comprising:
extruding a membrane;
applying a coating composition to at least part of the membrane to form a coating layer; and
curing the membrane and the coating layer to form a cured-coating layer on the membrane.

15. A method of making a membrane according to claim 14, further comprising the step of allowing the coating layer to dry after the coating composition is applied on the membrane, wherein the coating layer is substantially non-tacky after drying.

16. A method of making a membrane according to claim 15, further comprising the step of dusting the membrane having the coating layer with a dusting agent after the coating layer has dried and before the step of curing.

17. A method of making a membrane according to claim 16, further comprising the step of winding the membrane into a roll after the step of dusting the membrane and before the step of curing.

18. A method of making a membrane according to claim 14, wherein the coating composition is applied to the membrane using a metered priming rod.

19. A method of making a membrane according to claim 14, wherein the step of curing the membrane is performed by subjecting the membrane to UV light.
